(19) United States
(12) Patent Application Publication
(10) Pub. No.: US 2005/0198317 A1
(43) Pub. Date: Sep. 8, 2005

(54) Method and apparatus for sharing internet content

(76) Inventor: Charles Calvin Byers, Wheaton, IL (US)

Correspondence Address: JENNER & BLOCK LLP, ONE IBM PLAZA, CHICAGO, IL, 60611, US

(21) Appl. No.: 10/794,210

(22) Filed: Feb. 24, 2004

(51) Int. Cl. G06F 15/16

(52) U.S. Cl. 709/228; 707/10

(57) ABSTRACT

A method for sharing content over a network is provided. According to the method, a plurality of requests (200) for receiving content are received by a server (102) from user terminals (106). And, announcements of content or playlists (206, 214) that are to be broadcast are received from broadcast devices (108). The requests for content are analyzed to determine if the desired content is scheduled to be broadcast, as indicated in an announcement or playlist from a broadcast device. If the desired content is scheduled to be broadcast, then the user terminal is notified, and a recording of the broadcast is preferably, automatically arranged at the user terminal. The desired content is recorded with leading and trailing advertisements. Hence, to perceive the content, the advertisements must be perceived.

### FIELD OF THE INVENTION

The present invention relates generally to network file sharing, and in particular, to a method and apparatus that provide for users to share content, such as music, film, video and multimedia files, over the Internet.

### BACKGROUND OF THE INVENTION

The Internet is quite popular for downloading and sharing content such as music files, movies, and the like. However, some forms of sharing are disfavored, in view of the copyright laws. In particular, with the legal attack and dissolution of free peer-to-peer music sharing services like Napster, people desiring to download and share music and other content for their personal use are limited to few options other than paying for downloads over a fee-based service. This has the drawback that it actually cost the consumer money, which is undesirable for many consumers.

Therefore, a need exists for an improved method and apparatus for sharing Internet content without high cost to the consumer.

### SUMMARY OF THE INVENTION

The need is met and an advance in the art is made by the present invention, which provides an alternative to fee-based download services by using web-based broadcasts as a source for content. More specifically, a server coordinates with web broadcasts and users desiring content to connect users desiring content with web broadcasts providing the desired content. As a result of this connection, users can record and store the desired content from the web broadcasts. These recordings include some advertisements, which may be targeted to the user, and which provide an opportunity for underwriting the cost of providing the content to consumers.

In accordance with one aspect of the present invention, a method for sharing content over a network is provided. According to the method, a request for receiving content is received from a user terminal. And, an announcement of content or playlist is received from a broadcast device. The announcement of content or playlist is preferably received from one or more of a plurality of broadcast providers, web broadcast stations or streaming media sources. The request for content is analyzed to determine if the desired content is scheduled to be broadcast, as indicated in an announcement or playlist from a broadcast device. If the desired content is scheduled to be broadcast, then the user terminal is notified before the scheduled start of the broadcast, and a recording of the broadcast is preferably, automatically arranged at the user terminal. The desired content is recorded with leading and trailing advertisements. Hence, to perceive the content, the advertisements must be perceived.

In another aspect of the invention, a network server is provided. The network server includes a processor. The processor is programmed such that the server receives requests for receiving content from users. Preferably, the server provides a library of potentially available content. The processor is programmed such that the server receives announcements of content or playlists indicating content that will be played at a specific time. The announcements or playlists preferably are provided from a plurality of computers that broadcast content. The processor is programmed to match content requests from users with content that will be provided by a broadcaster. Statistics, such as the number of request for specific content, demographics, and the timing of requests for specific content, are maintained and preferably used to select and price the advertisements and slots for advertisements. When there is a match between content that is desired and content that is scheduled to be broadcast, the user seeking the content is notified. Preferably, the notification is made via email, instant message or a direct IP connection. After notification, certain user specific information is used to preferably record the desired content at the desired time on the user's local computer storage. This recording includes trailing and leading advertisements.

### BRIEF DESCRIPTION OF THE DRAWINGS

FIG. 1 is a block diagram of a network system that includes a server for sharing content in accordance with the present invention.

FIG. 2 is a block diagram illustrating exemplary data used in a method for sharing content over a network in accordance with the present invention.

FIG. 3 is a flow chart illustrating a method for sharing content over a network in accordance with the present invention.

### DESCRIPTION OF THE PREFERRED EMBODIMENTS

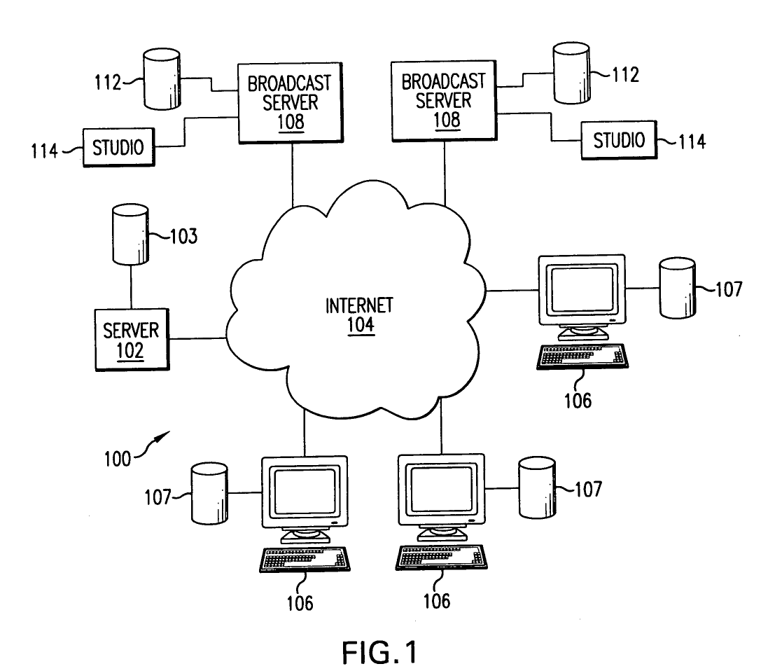

FIG. 1 is a block diagram of a network system 100 that includes a server 102 that provides a method and apparatus for sharing network content in accordance with a preferred embodiment of the present invention.

Network system 100 preferably includes a network infrastructure such as the Internet 104. As is well known in the art, the Internet 104 includes transmission paths and network devices for transmitting, routing and receiving packets.

Network system 100 preferably includes a plurality of user terminals 106. User terminals 106 provide users an interface for accessing the Internet 104. User terminals 106 preferably include local storage 107 to hold the received content. Network system 100 also preferably includes a plurality of broadcast servers 108. Broadcast servers 108 supply broadcast content over the Internet 104. Broadcast servers 108 preferably store content on disk 112.

Server 102, user terminals 106, and broadcast servers 108 are coupled to the Internet 104 in any known manner. Server 102 is preferably a single or multiprocessor computer or server farm that is optimized for receiving and processing data from the Internet 104. User terminals 106 are preferably personal computers, but may be any data networking devices that couple to the network, Internet 104. Broadcast server 108 is preferably a single or multiprocessor computer that is optimized for sending data over the Internet 104 and storing entertainment content, such as music and movies. Broadcast servers 108 also may include broadcast studios 114 for live creation of streaming content and to accommodate live announcers.

In accordance with the present invention, users desiring to download some specific content use user terminals 106 to make download requests that are received by server 102. In particular, disk 103, which is coupled to server 102, stores user requests for specific content. Broadcast servers 108 make content available to other devices coupled to the Internet 104 via streaming or an analogous mechanism. This allows devices to receive content as it is broadcast from broadcast servers 108. In accordance with the invention, prior to sending content over the Internet 104, broadcast servers 108 send a content announcement or playlist to server 102. The content announcements or playlists are preferably stored on disk 103 for use by server 102. As discussed more fully below, server 102 is programmed to associate user requests with content announcements and playlists such that user terminals 106 may receive and store desired content.

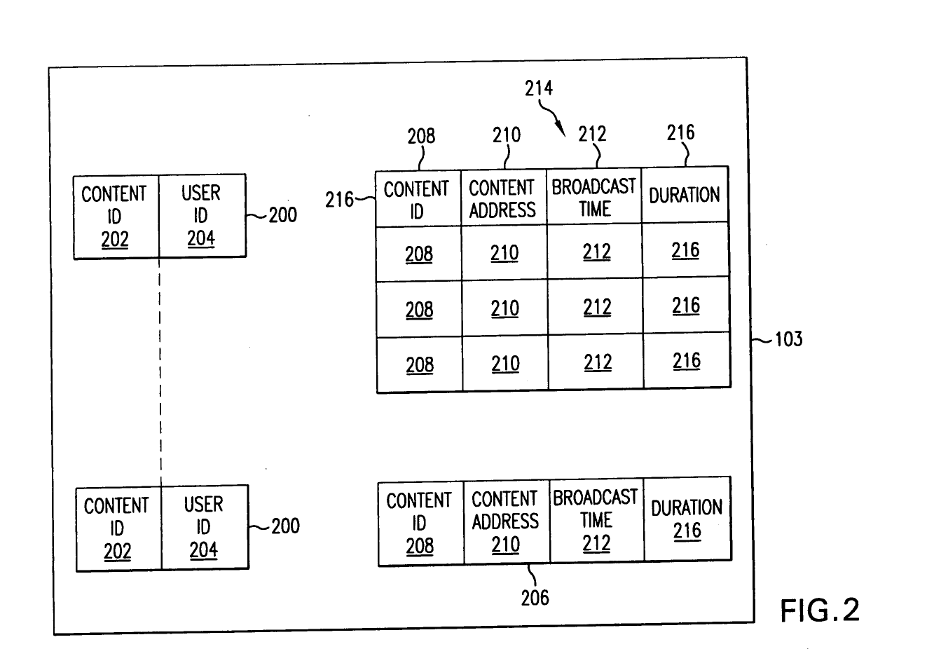

FIG. 2 is a block diagram illustrating an exemplary data structure for disk 103 of server 102, shown in FIG. 1. A plurality of user requests 200 are shown. User requests 200 indicate content that is desired by a particular user. In a preferred embodiment, user requests 200 include a content identification 202 and a user identification 204. Content identification 202 preferably includes some information to identify the specific content that is desired by a user. For example, content identification 202 may include the title of a song or movie, the artists associated with a song or movie, a date associated with specific content, a producer of specific content, or any other information that is useful in specifying particular content that is desired. User identification 204 preferably includes some information to identify the user making the request and to contact the user making the request. User identification 204 includes, for example, and e-mail address, IP address, account ID, telephone number, demographics, or any other identification for a user.

An exemplary content announcement 206 is shown in FIG. 2. Content announcement 206 is an indication from a broadcast server 108 of specific content that will be broadcast or otherwise made available over the Internet 104. Content announcement 206 preferably includes a content identification 208, a content address 210, a broadcast time 212 and a duration 216. Content identification 208 preferably includes some information to identify the specific content that will be broadcast. Most preferably, content identification 208 mirrors and is analogous with content identification 202. Content identification 208 preferably includes the title of a song or movie, the artists associated with a song or movie, a date associated with specific content, a producer of specific content, or any other information that is useful in specifying particular content that will be broadcast. Content address 210 preferably includes the identification of a location for receiving the content, that is, the channel identification, station URL, broadcast address, or the like, for receiving the broadcast. Content address 210 preferably includes an IP address or URL (uniform resource locator) and may include information specific to the format in which the content will be broadcast. Most preferably, content address 210 includes enough information for a user to locate, receive and store content that is to be broadcast. Broadcast time 212 preferably identifies the approximate time that the content identified in content identification 208 broadcast from the content address 210. Broadcast time 212 preferably includes one or more dates and times to indicate when content will be broadcast. Duration 216 preferably includes a length of the broadcast. Note that because of the non-deterministic nature of the latency of the broadcast connections through Internet 104, the actual start times and durations of the broadcasts arriving at terminals 106 may only be accurate to a window of many tens of seconds. Because of this, to insure the entire length of the desired content is stored on 107, terminals 106 must commence recording many seconds before the scheduled beginning time of the content, and must continue to record many seconds past the scheduled duration. If the user desires a copy of the stored content that exactly matches the starting and ending boundaries of the content, an editing step to trim the leading and trailing seconds from the content is required. This editing step is key to the present invention, as it is during this interval that the user is forced to perceive the advertisements that immediately precede and follow the content.

Broadcast servers 108 can intentionally add a few seconds of random jitter to the start time of their stated content. This eliminates the possibility of users of terminal 106 learning the typical propagation delay of a particular broadcast server's stream, thereby bypassing much of the appended advertisements.

An exemplary playlist 214 is shown in FIG. 2. Playlist 214 includes multiple listings of content that will be broadcast. Each playlist entry 216 preferably includes a content identification 208, a content address 210, a broadcast time 212, and a duration 216. Playlist 214 provides a mechanism for a broadcast server 108 to provide multiple listings of content to server 102 well in advance of broadcast of the content.

In addition to the information described above, user requests 200, content announcements 206 and playlist 214 may include additional information that is useful in connecting certain user request with certain content. For example, demographic data or data indicating a particular interest of a user may be used to connect that user with specific advertising that will be supplied in connection with the broadcast of content. Other exemplary information includes the artist, conductor, subject, director, media format, resolution, and sample rate.

As will be appreciated by those of skill in the art, many, many entries of user requests 200, content announcements 206 and playlists 214 are preferably stored, searched and managed by server 102 using processing power and database management tools. Various wildcard and fuzzy logic search methods, as known in the art, may be employed to improve the effectiveness of the search phase.

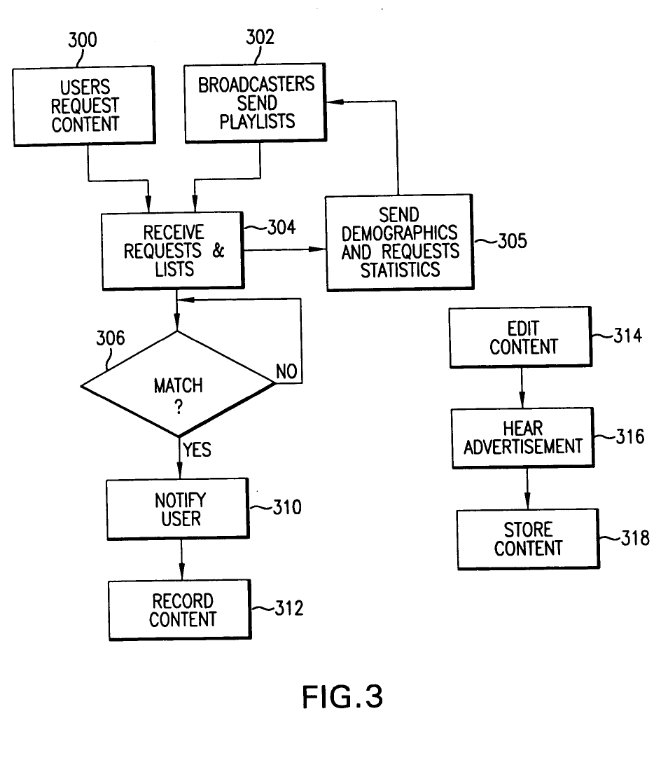

FIG. 3 is a flow chart illustrating a method for sharing content over a network in accordance with the present invention. In particular, FIG. 3 illustrates a method for sharing content using a preferred embodiment shown in FIG. 1 and FIG. 2.

According to the method, user requests for content are received by server 102 (300). The user requests are generated and sent to server 102 in any known manner. For example, user requests may be generated by a software program running on a user terminal 106 and communicated over the Internet 104. Alternatively, user requests may be generated by an interface on user terminals 106 that couples a user over the Internet 104 directly to server 102. Most preferably, the system for processing user requests includes an interface that permits a user to search for and identify desired content. Searches are preferably made using the artist, title, or any other indicia. Lists of most frequently requested content are also available for retrieval by both terminals 106 and broadcast servers 108 from server 102.

Independent of user requests, broadcast servers 108 send content announcements 206 and playlist 214 to server 102 (302). Content announcements and playlist are generated and communicated to server 102 in any known manner. For example, playlist 214 and content announcements 206 may be automatically generated by the broadcast servers 108 as content is loaded or otherwise prepared for broadcast. Alternatively, live announcers can enter content ID just prior to broadcasting the content.

Server 102 receives the user requests 200 and the content announcements 206 and playlists 214 (304). Preferably, this data is received over the Internet 104 in any known manner. Server 102 organizes the user requests 200, content announcements 206 and playlists 214 that are received from many users and many broadcasters. Preferably, a centralized or distributed database management system is used to organize user requests 200, content announcements 206 and playlists 214.

As user requests 200, content announcements 206 and playlists 214 are received, server 102 preferably performs a search function and determines if there are any matches between content desired by a user, as determined from a user request 200, on the one hand, and content that will be broadcast, as determined by a content announcement 206 or a playlist 214, on the other hand (306). Other considerations may also be used in making matches where such considerations are provided for. For example, if demographics is important, a match may be made only where a user's demographics matches the broadcaster's requirements, or vice versa.

Once a match in desired content is made with content to be broadcast (306), a user associated with the match is notified (310). Preferably, a broadcast server 108 that is providing the desired content is also notified. Notification to the user is preferably made to user terminal 106 using the user identification 204 supplied with the user request 200. Notification is preferably made through communication with an IP address associated with the user, email, instant messaging or another form of electronic communication. Notification to the broadcast server 108 may be made through an electronic communication to convey statistical and demographic data.

After a user is notified (310), the user terminal 106 preferably connects to and records the desired content at the broadcast time 212 associated with the content (312) for duration 216. Record step 312 preferably connects user terminal 106 to the broadcast server's 108 output over the Internet 104, and stores the received content on local storage 107. The notification message that is derived from content announcement 206 or playlist 214 provides the information necessary for connecting to and recording the content. In particular, the content address 210 includes the information necessary for a user terminal to receive and record the broadcast content. As an alternative to the user terminal storing content, server 102 may store the desired content for later retrieval by a user terminal 106.

In yet another alternative, server 102 may receive broadcast streams from broadcast servers 108, store them briefly, and rebroadcast them to terminals 106. This short delay can improve the performance of the system in cases where content is identified as a sub-channel of the broadcast stream, but broadcast servers 108 do not forward content announcements 206 or playlists 214 to server 102 in advance of the start of the broadcast of the content. In other words, where no content announcement 206 is made in advance, server 102 may determine the content of a broadcast, store that broadcast and rebroadcast the content for receipt by a user terminal 106.

At any desired time after the content is recorded (312), the user may edit and perceive the content (314). Since the timing of the broadcast of content is not precise, the user terminal 106 (or server 102) typically records tens of seconds of the broadcast before and after the desired content. Preferably, these tens of seconds include advertisements. In order for the user to store the desired content precisely, an editing step is required to trim the extra material leaving only the desired content. The editing step exposes the user to the advertisements (316), which is quite desirable for advertisers, and hence, provides incentive for the advertisers to defray the cost of the downloaded content for the benefit of the user. Once the desired content is edited from the recorded broadcast, the final trimmed version of the content may be stored, archived or uploaded to a portable playback device (318).

The infrastructure and methods described herein provide a new paradigm in obtaining useful and entertaining content. Many variations are possible within the framework proposed. For example, each broadcaster that uses a server 102 can use the user requests for content to play highly demanded content, as determined from user requests statistics (305). Broadcasters can receive request queues and demographic lists from server 102, and use this data in order to influence their future play lists in order to best serve the largest population or most desirable demographics (305). Also, the demographics for a particular user may be used to target advertisements specifically for that user or user group (305, 302). The operators of server 102 may receive a small payment from broadcasters for demographic data and the like. Also, the operators of server 102 may receive payment for downloading the software necessary for users and broadcasters to participate in the content sharing. Users of terminals 106 preferably complete a registration process upon their first use of server 102, and during that registration process, demographic data for the user may be collected for later use.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A method for sharing content over a network, the method comprising the steps of:
receiving a request for content over the network from a user terminal, wherein the request for content includes a first content identification;
receiving an announcement of content that is to be broadcast from a broadcast server over the network, wherein the announcement of content includes a second content identification;
determining whether the first content identification matches the second content identification; and
notifying the user terminal if the first content identification matches the second content identification.

2. The method of claim 1 further comprising the step of a user terminal recording content to produce a recorded content in response to receiving notification that the first content identification matches the second content identification.

3. The method of claim 2 wherein the step of notifying the user terminal includes providing the user terminal a content address, a broadcast time and duration.

4. The method of claim 3 wherein the step of recording content includes recording an advertisement.

5. The method of claim 4 wherein the step of recording content includes recording an advertisement before and an advertisement after a desired content identified by the first content identification.

6. The method of claim 4 further comprising the step of editing the recorded content to remove the advertisement.

7. The method of claim 6 wherein the step of editing includes perceiving the advertisement.

8. The method of claim 6 further comprising saving the recorded content on a portable device.

9. The method of claim 1 further comprising sending the request for content to a broadcast server.

10. The method of claim 9 further comprising the broadcast server determining a content to broadcast based on the request for content.

11. The method of claim 1 wherein the user terminal completes a registration and the registration includes demographics associated with the user terminal.

12. The method of claim 1 further comprising the steps of:
receiving content that is broadcast to produce a received content;
delaying the received content for a predetermined time; and
broadcasting the received content.

13. A network server for facilitating sharing content over a network, the network server comprising:
a processor that:
receives a request for content over the network from a user terminal, wherein the request for content includes a first content identification;
receives an announcement of content that is to be broadcast from a broadcast server over the network, wherein the announcement of content includes a second content identification;
determines whether the first content identification matches the second content identification; and
notifies the user terminal if the first content identification matches the second content identification.

14. The network server of claim 13 wherein the processor notifies the user terminal of a content address and a broadcast time and duration.

15. The network server of claim 13 wherein the processors sends a plurality of user requests for content to a broadcast server.

16. The network server of claim 15 wherein the announcement of content is determined by the broadcast server based on the plurality of user requests.

17. A method for receiving content over a network, the method comprising:
sending a request to receive content, the request including a content identification and a user identification;
receiving a notification that a broadcast will include the content identification, the notification including a content address, a broadcast time and duration; and
recording content to produce a recorded content based on the content address at the broadcast time.

18. The method of claim 17 wherein the step of recording content includes recording an advertisement.

19. The method of claim 17 wherein the step of recording content includes recording an advertisement before or after content identified by the content identification.

20. The method of claim 18 further comprising editing the recorded content to remove the advertisement.
